(19) United States
(12) Patent Application Publication
(10) Pub. No.: US 2021/0348792 A1
(43) Pub. Date: Nov. 11, 2021

(54) METHOD, SYSTEM AND APPARATUS FOR CONTROLLING SENSING DEVICES OF A HVAC SYSTEM

(71) Applicant: ZEN ECOSYSTEMS IP PTY LTD, Box Hill, Victoria (AU)

(72) Inventors: James Lawrence MCPHAIL, Redlands, CA (US); James MURACA, Hoppers Crossing, Victoria (AU); Grant Ian L. HATAMOSA, Bayswater North, Victoria (AU)

(21) Appl. No.: 17/277,335

(22) PCT Filed: Sep. 20, 2019
(86) PCT No.: PCT/AU2019/000111

§ 371 Date: Mar. 18, 2021

(30) Foreign Application Priority Data
Sep. 20, 2018 (AU) 2018903536

(51) Int. Cl. F24F 11/47; F24F 11/49; F24F 11/56

(52) U.S. Cl. CPC F24F 11/47; F24F 11/56; F24F 11/49

(57) ABSTRACT

The present application relates to the field of energy consumption. In one form, a method of controlling a number of sensing devices includes the steps of: forming a queue of a number of sensing devices, selecting one of the sensing devices, storing the settings of the selected sensing device, determining at least one active mode of the selected sensing device, calculating a sleep time for the selected sensing device, and operating the selected device with its stored settings in accordance with the calculated sleep time.

### FIELD OF INVENTION

The present invention relates to the field of energy consumption. In particular, the invention relates to a method, system and apparatus for controlling and optimising energy consumption of a building and/or energy consuming appliances, equipment or devices of a building. It will be convenient to hereinafter describe the invention in relation to the use of an API service in providing control over a plurality of thermostats to reduce peak energy usage across a group of thermostats, however it should be appreciated that the present invention is not limited to that use, only. For example, it will be readily apparent to the person skilled in the art that the present invention could be extended to control of other devices such as water pumps to reduce peak water usage across a group of pumps.

### BACKGROUND ART

Throughout this specification the use of the word “inventor” in singular form may be taken as reference to one (singular) inventor or more than one (plural) inventor of the present invention.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Heating, ventilation and air conditioning (HVAC) encompasses technology directed to the measurement and/or control of indoor environmental conditions to provide thermal comfort and acceptable air quality inside a building or vehicle. HVAC system design is an engineering discipline based on principles including thermodynamics, fluid mechanics, and heat transfer.

HVAC is an important part of residential structures such as single standing family homes, apartment buildings, hotels and senior living facilities, as well as medium to large industrial and office buildings such as skyscrapers and hospitals. It is also utilised onboard vessels, and in marine environments, where safe and healthy building conditions are regulated with respect to temperature and humidity, using fresh air from outdoors.

As noted in a background discussion in the prior art of US patent publication No. 2015/0370621 (Karp et al), people interact with a number of different electronic devices on a daily basis. In a home setting, for example, a person may interact with smart thermostats, lighting systems, alarm systems, entertainment systems, and a variety of other electronic devices. To interact with some of these electronic devices, a person may communicate a command using an application program running on another electronic device. For instance, a person may control the temperature setting on a smart thermostat using an application program running on a smartphone. The application program may communicate with a secure online service that interacts with that thermostat. Karp et al, however, is directed to addressing a problem concerning opening access to electronic devices (eg a thermostat etc.) to third-party developers, which might improve the user's experience with the devices but only if the third-party application programs do not cause the devices to behave in an undesirable manner and so it may be desirable to place restrictions on that third-party access to reduce risk of third-party access impacting the operation of devices and thus the user experience associated with those devices. The solution provided by Karp et al. is that applications may access different installations of smart home devices (e.g., via an application programming interface (API)). Namely, the third-party applications may communicate not directly with a smart home device, but rather through a device service. The device service may provide a corresponding update signal to the target smart home device based on one or more factors such as operation status parameters of the device. Accordingly, Karp et al is directed to the ability to monitor and control a device or a plurality of devices via an API.

Some further examples of prior art device control and HVAC systems are as follows.

US patent publication No. 2016/0201932 (Endo et al) relates to an air conditioner control system sensor device control method in which an air conditioner operates based on the temperature measured by a wireless measurement terminal. It is directed to the problem arising where multiple wireless measurement terminals are provided and, in many cases, their batteries die, or their remaining charge amounts fall below a given value at different times depending on the wireless measurement terminals. This leads to a problem that batteries are replaced at different times for each wireless measurement terminal, whereby the maintenance work is laborious. The solution disclosed provides an air conditioner control system comprising one or more air conditioners configured to condition an environment in a target space, an integrated controller configured to communicate with the one or more air conditioners, a relay device configured to communicate with the integrated controller, and a plurality of sensor devices each comprising a battery supplying power for operation and configured to wirelessly communicate with the relay device. The integrated controller comprises air conditioner control means for controlling the one or more air conditioners based on control parameter data. Each of the sensor devices comprises measuring means for measuring an environment value of the target space and sending measurement data including the measured environment value to the relay device and sleep control means for effecting, according to a sleep time decided by the relay device, a sleep mode in which power consumption is lower than in a normal mode. The relay device comprises control parameter creation means for creating the control parameter data based on the measurement data received from each of the plurality of sensor devices and sleep time deciding means for deciding, according to the remaining charge amounts of the batteries, the sleep time so that at least two sensor devices of the plurality of sensor devices run out of battery charge around the same time. Advantageously, the sleep time is decided according to the remaining charge amounts of the batteries so that at least two sensor devices run out of battery charge around the same time. The sensor devices will be in the sleep mode in which power consumption is lower than in the normal mode according to the decided sleep time thereof. As a result, the batteries of two or more sensor devices can be replaced around the same time and thus it is possible to reduce maintenance-related labor accompanying exhaustion of the batteries. Effectively, the method and system described by this prior art is for the conservation of power of a given device so it can further extend its own operational life before replacing batteries is required.

Another prior art example of control of devices in a HVAC system is disclosed in International Patent publication No. WO 2014/136585 (Mitsubishi Electric Corporation), which relates to a measurement system, an integrated controller, a program, and a sensor device control method for measuring temperature and the like using a sensor device. As with Endo et al noted above, this prior art disclosure is concerned with providing a solution for battery life savings of a temperature control appliance(s). In particular, it is concerned with providing a measurement system, an integrated controller, and a sensor device that can suppress the consumption of a battery serving as a power source of the sensor device without hindering the operation of the facility device. A measurement system is provided in which a sensor device enters a sleep state according to sleep time and/or sleep interval determined based on the operation state of the facility device. As a result, it is possible to suppress the consumption of the battery serving as the power source of the sensor device without hindering the operation of the facility device.

HVAC systems and their components developed hand-in-hand with the industrial revolution, and new methods of modernization. Higher efficiency, and system control are constantly being introduced by companies and individuals worldwide. Energy consumption management has become an economic imperative wherever there is a greater need to optimise use of energy resources. There have been numerous attempts in the prior art to manage and optimise energy usage and examples follow.

As energy supplies become more expensive or volatile, suppliers and consumers have sought ways to reduce their respective energy consumption and energy costs with HVAC systems. Many energy systems have been developed to allow users to schedule how and when energy systems should be used.

By way of example, a HVAC system may allow a user to set temperatures for different times of day, such as a “wake” time and temperature, an “away” time and temperature, a “return” time and temperature, and a “sleep” time and temperature. At the predetermined times, the system adjusts to the predetermined temperatures. However, these systems require a user to configure them properly and adjust the times and temperatures to adapt to changing energy consumption or production needs.

Weather is a major variable impacting on home energy demand and the automatic adjustment of temperature may be conducted by a utility that provides power to the home based on weather information. However, adjustments are often based on incomplete or inaccurate weather information for the precise location of the home and do not factor in the occupants personal preferences. In addition, these systems are generally not capable of accounting for the thermal characteristics of the building in which the thermostat is installed. As a result, such systems are reactive to current weather conditions and temperature needs of the home, rather than performing pre-heating and/or pre-cooling based on forecast weather conditions and the energy characteristics of the home.

With a conventional energy management approach, a residence may manage its own energy. However, due to limitations of conventional energy management devices, such as thermostats and the like, it can be difficult for a residence to efficiently and effectively manage energy usage on its own. Furthermore, conventional thermostat systems aim to maintain a desired temperature within a residence, but because they are not sufficiently precise the temperature fluctuates. This fluctuation can result in varying energy consumption, and variable energy cost.

During peak energy demand periods, commercial energy providers (such as utilities providers and service providers) are often forced into short-term purchase of energy resources at premium prices and pass on the high costs to its energy customers. Within commercial energy systems, when providers fail to maintain adequate energy resources, this can lead to power outages that affect the general public and can tarnish the reputation of the providers and adversely affect their business. As a result, in these circumstances, providers often lose millions of dollars every day in order to maintain adequate energy resources.

In order to manage peak energy demand periods, some providers establish reduction compensation programs and pay consumers to temporarily reduce their energy consumption during peak energy demand periods. Advantageously, consumers electing to participate in a curtailment event (such as a compensation program) may be incentivized by being able to purchase energy during peak energy demand periods at energy costs lower than no-peak periods. However, due to the high volatility of wholesale energy prices and the absence of energy management systems for determining real-time information tracking energy usage, consumer participation in reduction compensation programs is limited.

U.S. Pat. No. 9,471,082 (Sloop et al) describes a method that uses an algorithm as well as the observed thermal response of a building to optimise the energy consumption of a HVAC system. As a first step, the algorithm requires thermal response coefficients based on energy characteristics of the building to be input, and therefore would require a certain amount of initial setup time when the system is offline. This is considered cumbersome and inefficient.

US patent publication No. 2014/0039686 (Corbin) describes a method of meeting energy consumption goals by creating a simulation model of a HVAC system by monitoring the response of the system while performing test heating/cooling/free-float HVAC steps. This method relies on test steps to characterise the HVAC system, and therefore would require a certain amount of initial setup time when the system is offline, which is also considered cumbersome and inefficient.

U.S. Pat. No. 8,019,567 (Steinberg et al) describes a method of measurement of inside temperature and comparison with outside temperature to generate a baseline for the expected HVAC system ramp rate. The baseline is used to identify any deviations and assess HVAC system health. This method requires the HVAC system to be in operation during a ramping period and therefore would require a certain amount of initial setup time where the system is offline, which is also considered cumbersome and inefficient.

U.S. Pat. No. 7,848,900 (Steinberg et al) describes a method of characterising an operational efficiency of an HVAC system by monitoring the rate of change of an internal temperature at a first location when the system is both on and off and relating these to the associated external temperature of the building. This system would need to create a contrived set of events to facilitate generation of the model in the first instance. It is considered this limits the system to a cumbersome and inefficient process.

U.S. Pat. No. 9,008,846 (Pan et al) describes a method of implementing a thermostat lockout using pin code storage. Property-management or lock-setting thermostats have maximum and minimum set points locked in to prevent abuse of management-provided heating or air conditioning. An ePROM or similar internal memory device stores heating and cooling limit parameters that are set by a technician at the time of installation. A plug-in flash memory module contains an unlock code to match the unlock code stored in said ePROM, to unlock the thermostat and allow the settings to be adjusted. When said flash memory module is removed the thermostat reverts to its lock condition. The thermostat can also respond to unusual rates of change of temperature to block furnace or A/C (air conditioning) operation temporarily.

U.S. Pat. No. 6,868,293 (Schurr et al) describes a method of implementing demand response using a remote request. The method addresses a need for customizing curtailment events for individual consumer users and providing real-time notification and monitoring of curtailment events. It also identifies a need for a system and method for remotely controlling a thermostat device in a residence to achieve efficient energy management. In essence, the disclosed system performs energy usage management within a network, the system comprising: a thermostat associated with an energy consuming entity (such as a residence); a server remote from the energy consuming entity for performing one or more energy curtailment management operations within the network, the server being communicatively connected to the thermostat over the network and having a software application thereon for remotely controlling the thermostat in accordance with a particular energy curtailment management operation; and a database associated with the server for storing curtailment event information relating to the network.

U.S. Pat. No. 7,908,117 (Steinberg et al) describes a method of determining if an HVAC system is on or off and relating this to the expected behaviour based on historical measurements, following a demand response request. The disclosed solution comprises systems and methods for verifying the occurrence of a change in operational status for climate control systems. The climate control system measures temperature at least at a first location conditioned by the climate control system. One or more processors also receive measurements of outside temperatures from at least one source other than the climate control system and compares the temperature measurements from the first location with expected temperature measurements. The expected temperature measurements are based at least in part upon past temperature measurements obtained by the climate control system and the outside temperature measurements. A server transmits changes in programming to the climate control system based at least in part on the comparison of the temperature measurements with the expected temperature measurements.

There are some devices of the prior art which provide a greater level of detail about the energy usage in a building, but they all suffer from problems, such as the following:
many existing devices do not offer a low-cost way for a person to be on-site to monitor or record a relevant parameter such as current drawn from an apparatus or appliance or air temperature or humidity, i.e. for remote monitoring or control of a parameter that may not be easy or convenient to be physically near to;
the cost and complexity of installing and managing devices of the prior art often outweighs the benefits. The drive for greater efficiency and productivity favours simple, incumbent solutions with minimal capital expenditure and short learning curves.

There are many partial solutions to one or more of the problems noted herein, but no known complete solutions to the entire problem. By way of explanation known solutions of the prior art as identified herein have at least a major disadvantage in that they control apparatus function load, such as air conditioning load, only. In short, they may turn the system or apparatus off when a utility desires but take no consideration of household conditions or consumer/user need. This is generally unacceptable to consumers of energy. Aside from the issue of not wanting an outside party such as a public utility or an authority that could be seen as “big brother” imposing to turn a consumer's AC off, if a house gets very hot then this circumstance may become a potentially life-threatening health issue for occupants. In the latter circumstance prior art devices, by definition, do not take into account the internal temperature of a dwelling which they are controlling and so can be considered a life-threatening health hazard in the extreme but not uncommon circumstance.

The preceding discussion of background art is intended to facilitate an understanding of the present invention only. The discussion is not an acknowledgement or admission that any of the material referred to is or was part of the common general knowledge as at the priority date of the application.

### SUMMARY OF INVENTION

It is an object of the embodiments described herein to overcome or alleviate at least one of the above noted drawbacks of related art systems or to at least provide a useful alternative to related art systems.

In a first aspect of embodiments described herein there is provided a method of controlling a plurality of sensing devices comprising the steps of:

forming a queue of a plurality of sensing devices;

selecting one of the plurality of sensing devices;

storing the settings of the selected sensing device;

determining at least one active mode of the selected sensing device;

calculating a sleep time for the selected sensing device; and

operating the selected device with its stored settings in accordance with the calculated sleep time.

Preferably the sensing device is chosen from the group comprising thermostats, pumps or valves associated with the supply of heat/cooling, water or gas respectively.

Typically, the method steps of storing, determining, calculating and operating are performed for each of the sensing devices of the queue.

In a preferred embodiment, the sleep time is calculated according to:
tₛₗₑₑₚ=(t_{cycle}/Nₜₕₑᵣₘₒₛₜₐₜ)/N_{cph}
   where
      tₛₗₑₑₚ=Sleep time in seconds (s)
      t_{cycle}=Cycle duration in seconds (s)
      Nₜₕₑᵣₘₒₛₜₐₜ=Number of thermostats
      N_{cph}=Cycles per hour

Typically, determining at least one active mode of the selected sensing device includes determining whether the selected device is in one or a combination of the following modes:

ON;

OFF;

COOLING with a corresponding cooling setpoint allocated to the device;

HEATING with a corresponding heating setpoint allocated to the device.

Preferably, if the selected device is in either COOLING or HEATING mode, an adjusted cooling setpoint or an adjusted heating setpoint is calculated, respectively.

In another aspect of embodiments described herein there is provided a system for controlling a plurality of sensing devices, said system comprising an API service utilising a computer usable medium having computer readable program code and computer readable system code embodied on said medium for reducing peak energy usage across a group of the sensing devices within a data processing system, said computer program product including computer readable code within said computer usable medium for:

forming a queue of sensing devices;

selecting one of the plurality of sensing devices;

storing the settings of the selected device;

determining at least one active mode of the selected device;

calculating a sleep time for the selected sensing device;

operating the selected device with its stored settings in accordance with the calculated sleep time.

In yet a further aspect of embodiments described herein there is provided an apparatus adapted to control a plurality of sensing devices wherein each sensing device is operatively associated with a HVAC device within a HVAC system, said apparatus for reducing peak energy usage across a group of the sensing devices, said apparatus comprising:

processor means adapted to operate in accordance with a predetermined instruction set,

said apparatus, in conjunction with said instruction set, being adapted to perform the method of the present invention as herein described.

Other aspects and preferred forms are disclosed in the specification and/or defined in the appended claims, forming a part of the description of the invention.

In essence, embodiments of the present invention stem from the realization that uncoordinated supply of resources such as heat, water, gas and so forth leads to undesirable demand peaks. However, by ordering a plurality of sensors associated with supply sources, consumption of the resource can be optimised.

In a particularly apt example, when HVAC units are active without coordination, undesirable energy usage may result, including a high peak demand. However, by ordering a plurality of HVAC sensing devices in a suitable sequence, the operation of their corresponding HVAC unit can be coordinated to optimise energy consumption.

Advantages provided by the present invention comprise the following:
reduced resource and/or energy consumption,
optimised and coordinated operation of multiple resource supply sources,
flexibility for a user to control a trade-off between comfort or need and financial savings,
provision of dynamic adjustment of aggregated resource consumption,
ability to calculate expected individual and aggregate savings of the resource and associated cost,
permits a market operator to precisely dictate a resource or load savings curve,
provides more options and control for resource demand management schemes
optimised and coordinated operation of multiple resource supply sources.

Furthermore, the solutions provided by embodiments of the present invention are expected to improve the participation rate of incentive-based demand response programs. Generally speaking, in an incentive-based demand response program an energy focused company will give participants incentives in the form of hardware rebates, bill discounts, among other things. The participant rate may be greatly affected as the inconvenience far outweighs the perceived savings to the participant. Embodiments of the invention reduce the impact to the user's comfort by ensuring that for a site with multiple AC units that these units will not be switched off or applied with a setback at the same time.

In addition, embodiments of the present invention can maximise the energy reduction for a given organisation that may have one or many AC units on a site as well as a group of sites. The method, system and apparatus of embodiments of the present invention when applied will systematically reduce energy usage of AC units while making sure that overall comfort is not greatly affected.

Whilst the prior art provides control of one or more appliances or devices, such as for example by the provision of the ability to monitor and control a device or a plurality of devices via an API, embodiments of the present invention may also provide an API to monitor and control a device or a plurality of devices, but moreover, embodiments of the present invention go further and allow for an aggregated energy savings to be achieved through the systematic control of a group of devices. As such, the grouping of devices is also made using a systematic method to achieve optimum energy reduction for a given site, region, or organisation.

Where prior art examples may provide for the conservation of the power of a given device so it can further extend its own operational life before replacing batteries, for example, embodiments of the present invention calculate the sleep time to balance both comfort of the users affected as well as optimise the energy reduction of a given site, region, or organisation.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present invention may be better understood by those skilled in the relevant art by reference to the following description of embodiments taken in conjunction with the accompanying drawings, which are given by way of illustration only, and thus are not limitative of the disclosure herein, and in which:

FIG. 1 illustrates HVAC unit coordination according to a preferred embodiment of the present invention when OFF (FIG. 1A), when requesting to be ON (FIG. 1B) and when running (FIG. 1C);

FIG. 2 illustrates an embodiment of the present invention, in which all HVACs are off and the ambient temperature is below SP1;

FIG. 3 illustrates a further embodiment of the present invention, in which a predetermined number of HVACs are running;

FIG. 4 and FIG. 5 illustrate operation of the method of the present invention to coordinate operation of the HVACs in accordance with a preferred embodiment;

FIG. 6 is a flow chart illustrating the method and system of the present invention according to preferred embodiments;

FIG. 7 is a diagram illustrating how each individual HVAC thermostat operates according to an embodiment of the present invention;

FIG. 8 is a diagram illustrating operation of the global controller in accordance with an embodiment of the present invention;

FIG. 9 is a flow chart illustrating the operation of a further exemplary embodiment of the invention;

FIG. 10 is a flow chart illustrating the operation of a yet further exemplary embodiment of the invention;

FIG. 11 is a system diagram of components of a HVAC system controlled in accordance with a preferred embodiment of the invention;

FIG. 12 is a system diagram of further components of a HVAC system controlled in accordance with a preferred embodiment of the invention;

FIG. 13 is a system diagram of further components of a HVAC system controlled in accordance with another preferred embodiment of the invention;

FIG. 14 illustrates three different applications suitable for implementation of embodiments of the method of the present invention.

### DETAILED DESCRIPTION

FIG. 1 depicts a HVAC unit coordination according to a preferred embodiment of the present invention to avoid high peak demand situations of the prior art. In FIG. 1, each rectangle represents a HVAC, having a status of OFF (FIG. 1A), when requesting to change status to ON (FIG. 1B) and, when running (FIG. 1C). Each HVAC has a default

set-point and an elevated set-point. Set-point (SP) 1 and 2 are the default SP's that are used to control temperature in normal mode. SP1 is static (that is, SP1 does not change over time) and if the ambient temperature reaches SP1 the HVAC will turn OFF. If the ambient temperature hits SP2, the HVAC requests permission to switch ON

In contrast to normal mode, SP 2 is dynamic when the method of the present invention is active in accordance with the embodiment described. SP3 is used as a setback. SP4 is the maximal permissible ambient temperature during the coordination method of the present invention as set out in this embodiment.

A grace period may be pre-set—the grace period being the maximum time a HVAC can be in request mode before switching ON. Each HVAC may also have a pre-set minimal run time. For example, the runtime could nominally be set so that it runs for at least 10 mins once the HVAC is switched ON. Furthermore, each HVAC may have a pre-set minimal down-time. For example, once switched off, it nominally remains off for 10 min. Ideally the ambient temperature never reaches SP4 over the time the method is performed

### EXAMPLES

The following non-limiting examples are included to illustrate operation of the present invention in accordance with preferred embodiments. In these examples, only 50% of all HVAC's are allowed to run simultaneously. The settings (corresponding to the descriptions above) are SP1=22°, SP2=23°, SP3=25°, SP4=26°.

### Example 1

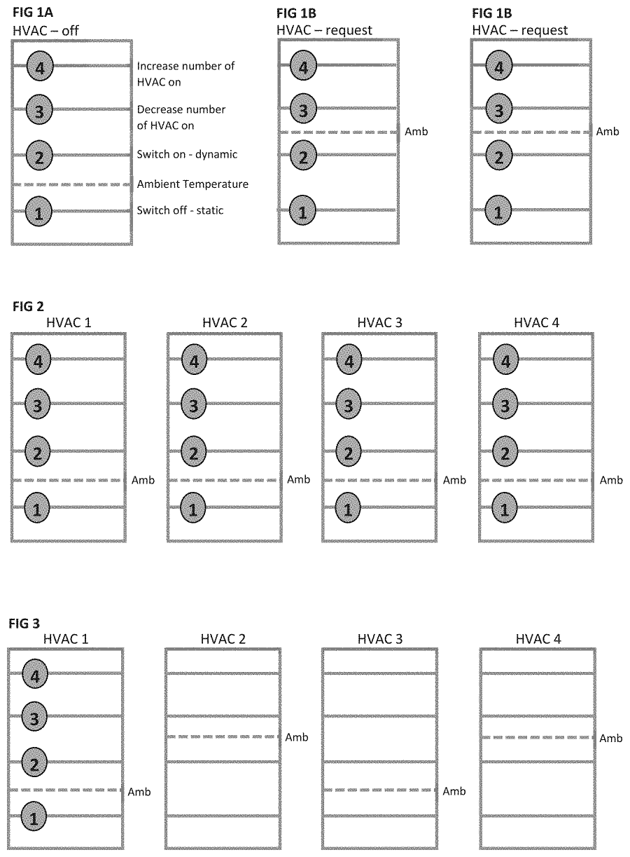

FIG. 2 illustrates Example 1, in which all HVACs are off and ambient temperature is below SP1.

### Example 2

FIG. 3 illustrates Example 2, in which a predetermined number of HVACs are running. Specifically, two HVACs (HVAC 2 and HVAC 4) are on.

### Example 3

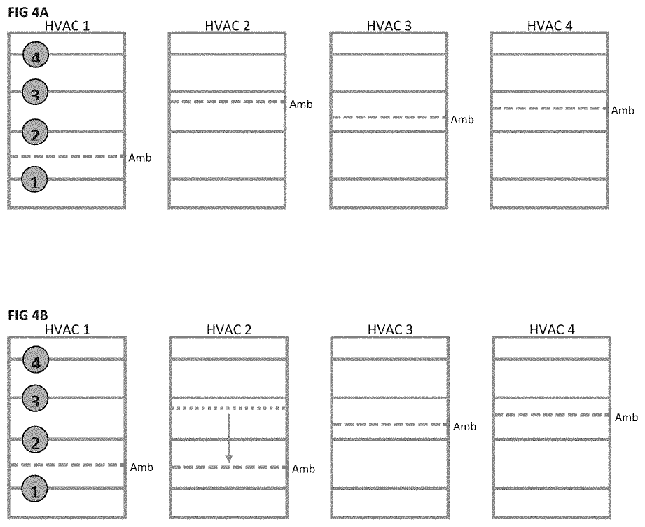

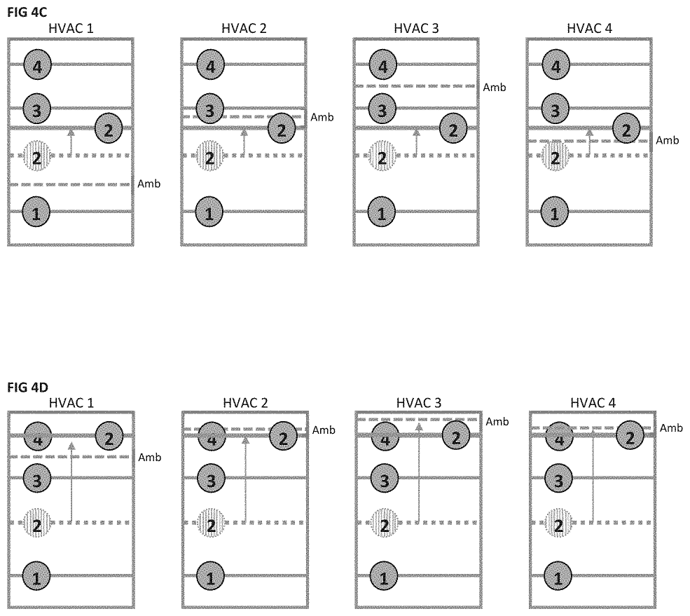

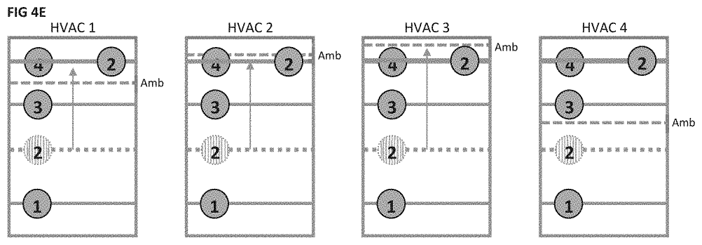

FIG. 4A illustrates Example 3, in which a predetermined number of HVACs are ON. One or more additional HVACs are requesting to be ON. Specifically, HVAC 3 has requested permission to switchON. However, before this can occur, one other HVAC must switch off, e.g. HVAC 2 or HVAC 4.

FIG. 4B illustrates the next phase of Example 3 when, during a grace period, (e.g. 10 minutes) a HVAC (e.g. HVAC 2) can be turned OFF as the ambient temperature decreases below SP2 (arrow). HVAC 2 would not turn OFF in the absence of a request because it has not reached yet SP1.

FIG. 4C illustrates a further phase of Example 3 when the ambient temperature of the rooms with HVAC ON does not fall below SP2 during the grace period, leading to an increase in SP2 to compensate. As a result, HVAC 4 can be switched off as the ambient temperature is below SP2.

FIG. 4D illustrates the next phase of Example 4 when increasing SP2 (FIG. 4C) with the aim of at switching OFF a HVAC that is currently running. It might happened that SP2 meets SP4. In this case, a number of additional HVACs must be turned ON, such as, for example 75% of all HVACs.

FIG. 4E illustrates an alternative situation which may occur if a number of HVAC's have not reached their minimal runtime. In this case, HVAC 4 continues to run as it has not reached its minimal runtime (e.g. 10 mins) yet.

### Example 4

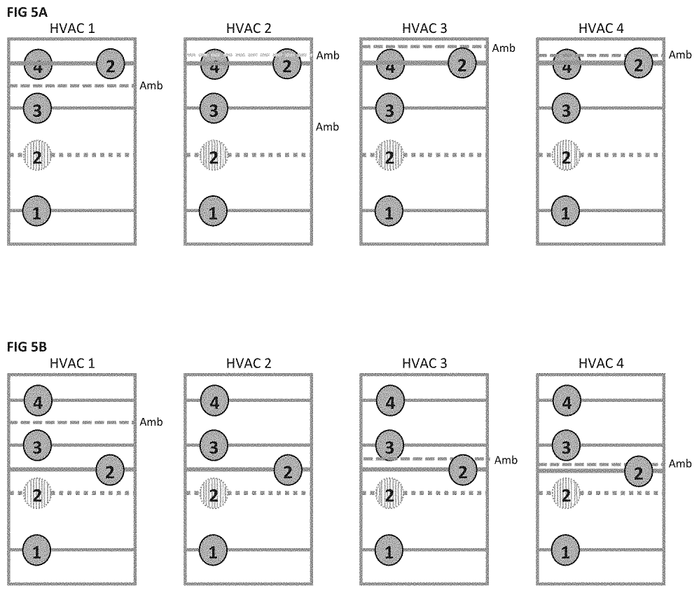

FIG. 5 illustrates Example 4. FIG. 5A illustrates a reset of the percentage of HVACs which can simultaneously be ON. FIG. 5B illustrates adjustment of SP2 towards its default value.

A difference between the embodiments of the present invention as described above and the normal mode of the prior art is that the system is configured in two parts—Part A and Part B.

Part A relates to each individual thermostat. Specifically, prior to turning on the HVAC, the thermostats request permission to turn on the HVAC. If permission is granted, the thermostat turns on the HVAC. The set-points SP1-SP4 do not have to be consistent across all individual thermostats.

Part B relates to the overarching controller. The controller is responsible for (i) granting permission to turn on HVAC, (ii) adjusting SP2, and (iii) adjusting the number of HVACs that are ON.

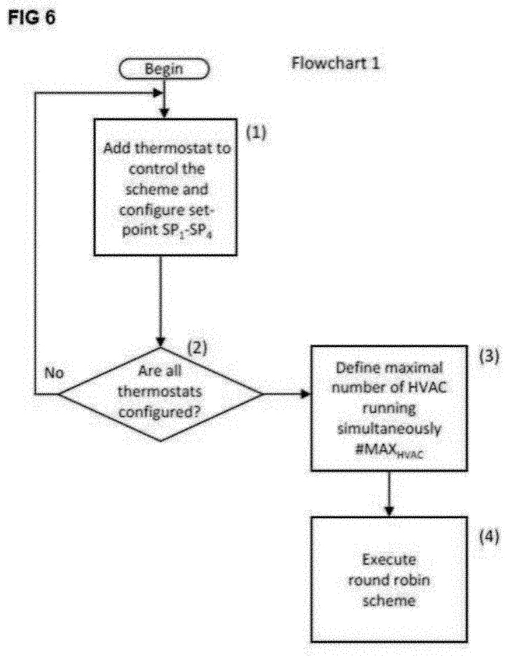

FIG. 6 is a flow chart further illustrating the generalized method and system of the present invention. Each thermostat to be controlled by the method of the present invention in this embodiment is added and the set-points SP1, SP2, SP3 and SP4 are set (1). Once all thermostats are added (2), the maximum number of simultaneously executed thermostats #MaxHVAC is defined (3) before the method is executed (4).

In this state, SP1 is fixed as the lowest set-point. The HVAC switches OFF as in standard thermostat hysteresis.

SP2 is a dynamic setting. If the T_{Ambient}>SP2, the HVAC requests permission to switch ON.

SP3 is fixed and is used to reduce the number of HVACs permitted to run simultaneously.

SP4 is also fixed. If T_{Ambient}>SP4 an additional HVAC is temporarily permitted.

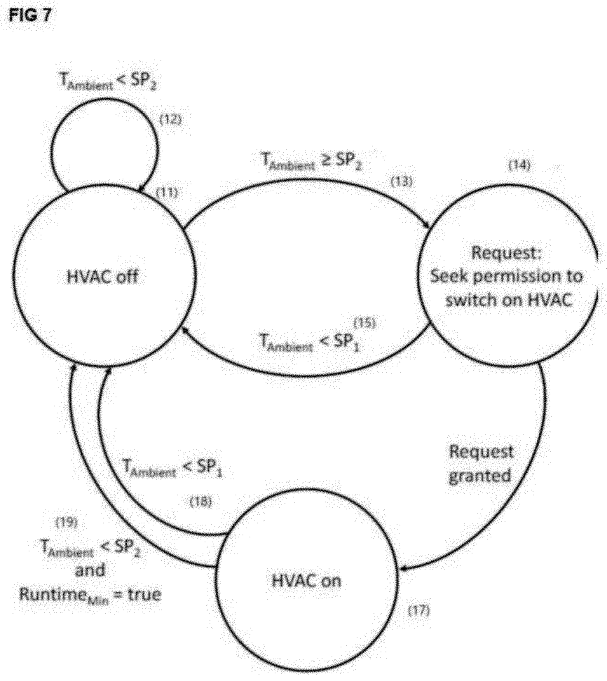

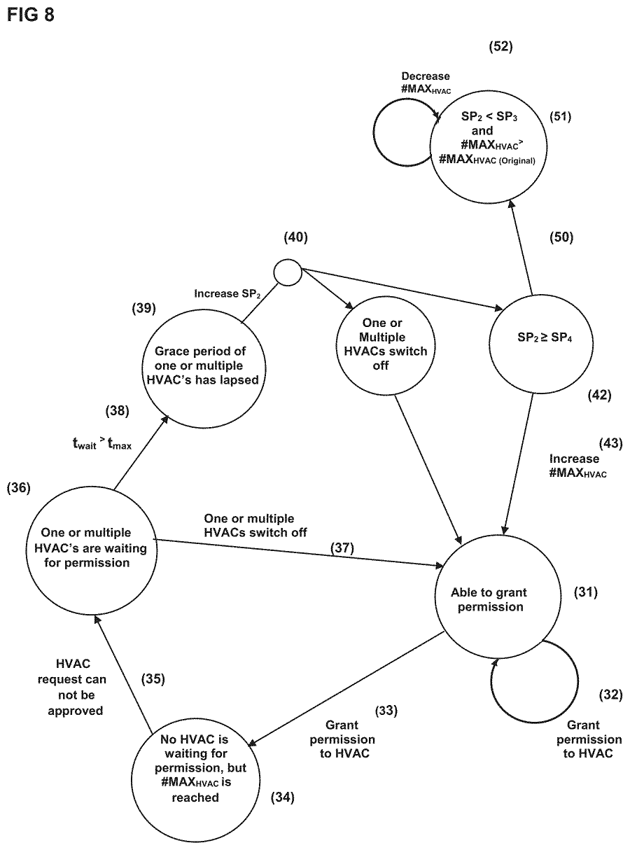

FIG. 7 is a diagram illustrating how each individual HVAC thermostat operates according to the present invention in accordance with a preferred embodiment. If the HVAC is OFF (11) and the ambient temperature (T_{Ambient}) remains below SP2, the HVAC remains OFF (12). If T_{Ambient} meets or exceeds SP2, a request to switch on the HVAC is send to the global controller (FIG. 8) (14). If T_{Ambient} falls below SP1 (15), the thermostat returns to state OFF (11). If the request is granted (from the global controller) the HVAC switches ON (17). When the HVAC is ON, T_{Ambient} either falls below SP1 (18) and returns the HVAC to OFF.

Alternatively, the HVAC OFF state can be reached if T_{Ambient}<SP2 and the runtime has exceeded RuntimeMin (which is the minimal time a HVAC must run) (19). This happens if another thermostat has requested permission to turn on the HVAC but the maximal number of HVAC is already enabled.

FIG. 8 is a diagram illustrating operation of the global controller. If a thermostat requests permission to turn the HVAC (31) ON, the global controller can grant this request if the number of HVAC's currently running is lower that the maximal number allowed; #HVACON (the number of HVAC's currently running) is below #MAX′HVAC (#HVACON<#MAX′HVAC). When no further thermostat is allowed to run, the controller goes into #MAXHAVAC reached state (34) via (33).

If the controller is in #MAXHAVAC reached state and another thermostat requests permission (35) the global controller goes into the waiting state (36). If the global controller is in the waiting state and one or multiple HVAC's switch OFF (37) such that #HVACON<#MAXHAVAC (37), the global controller returns to state ‘able to grant permission’ (31).

If the global controller is in the waiting state (36) and one or more HVACs have been waiting for longer than permitted (ie subject to a grace period tₘₐₓ) (38) t_{Wait}>tₘₐₓ the global controller will go into state ‘grace period lapsed’ (39) to then increase the set-point SP2 (40).

Increasing SP2, can either result in one or multiple HVAC switching OFF before SP2 reaches SP4. In this case, the global controller returns to state ‘able to grant permission’ (31). When increasing SP2, results in SP2 reaching SP4, the maximal number of HVAC's running simultaneously #MAXHVAC is increased (43) such that the global controller can return to the ‘able to grant permission’ state.

If the #MAXHVAC has been increased, a mean to decreasing again is required (50). This is where SP3 comes into play. The dynamic set-point SP2, decreases automatically with T_{Ambient} (given T_{Ambient} decreases). Once SP2 falls below SP3 (51), #HVACMAX, is decreased (52).

The following examples further describe or outline the requirements to implement two exemplary aspects of methods of controlling a plurality of thermostats via a custom API service to reduce peak energy usage across a group of thermostats to reduce operating costs of an energy consuming system such as a HVAC system.

### Example 5

In a first aspect of the control method the start of each device at a site is staggered so that all loads do not turn on at the same time resulting in a softer ramp up. In this example, the start is communicated by a change of mode, or an offset setpoint from the desired baseline. Secondly, the heating or cooling setpoint of each device is periodically adjusted/offset within a site in turn to force a given device to not become non-active.

FIG. 9 is a flow chart showing the operation of a first exemplary embodiment of the method of controlling thermostats to reduce peak energy usage across the group of thermostats. Upon invoking the control system, indicated as ‘BEGIN’ in FIG. 9, a select number of thermostats is added to a queue of devices at step 101. The selected number of thermostats can be a function of the number of devices in a building or any other conveniently controlled area within a building or devices spread throughout a number of buildings or precinct. In this respect, it is envisaged that an algorithm complying with the process steps of the flow chart of FIG. 9 may be run across a number of devices within the one room or one building, or across multiple devices in multiple buildings or other geographically dispersed areas. At step 102 the first thermostat is selected. At step 103 the selected thermostat's settings are stored. At step 104 the status of the active mode of the selected thermostat is determined, ie ‘ON’ or ‘OFF’. In the event that the device's active mode is ON, at step 106 the active mode is turned to OFF. Then at step 107 a sleep time, tₛₗₑₑₚ, is determined for the selected thermostat.

The sleep time is determined as follows:
tₛₗₑₑₚ=(t_{cycle}/Nₜₕₑᵣₘₒₛₜₐₜ)/N_{cph}
   where
      tₛₗₑₑₚ=Sleep time in seconds (s)
      t_{cycle}=Cycle duration in seconds (s)
      Nₜₕₑᵣₘₒₛₜₐₜ=Number of thermostats
      N_{cph}=Cycles per hour

For the avoidance of doubt, in the above determination of sleep time, a cycle refers to the period of time a device is in the setback phase. By way of example and with reference to FIG. 12, the highlighted (orange) block is changed to 78° F. for a 5-minute cycle duration.

At step 108 the selected thermostat is reverted to its saved/stored settings of step 103. With the sleep time programmed into the thermostat, on the expiry of the sleep time, it will operate with its saved settings. In other words, at the end of each cycle, the thermostat will return to its previous state. Whether or not the selected thermostat is the last in the queue is determined at step 109 then at step 111, the next thermostat in the queue is selected for processing as above.

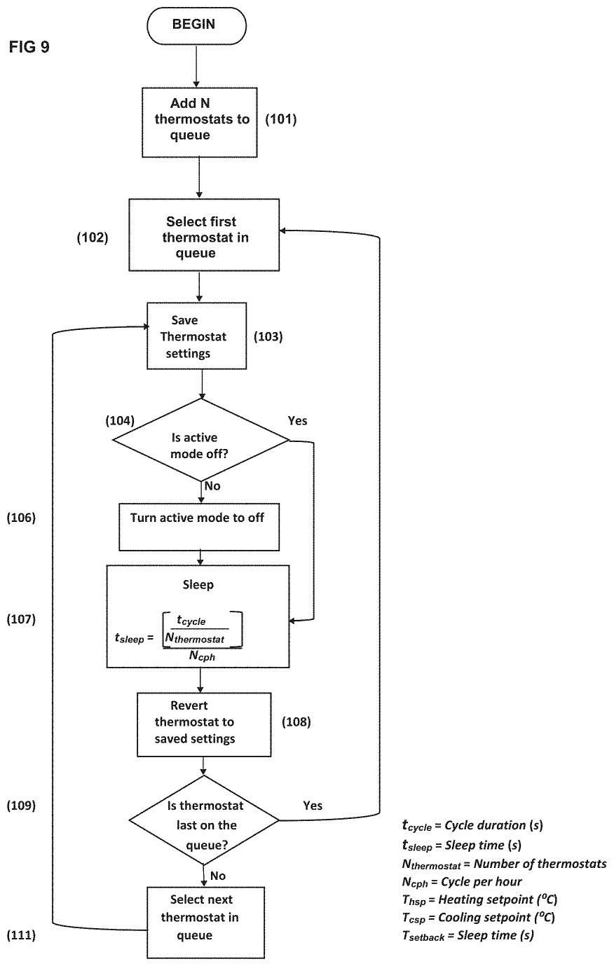

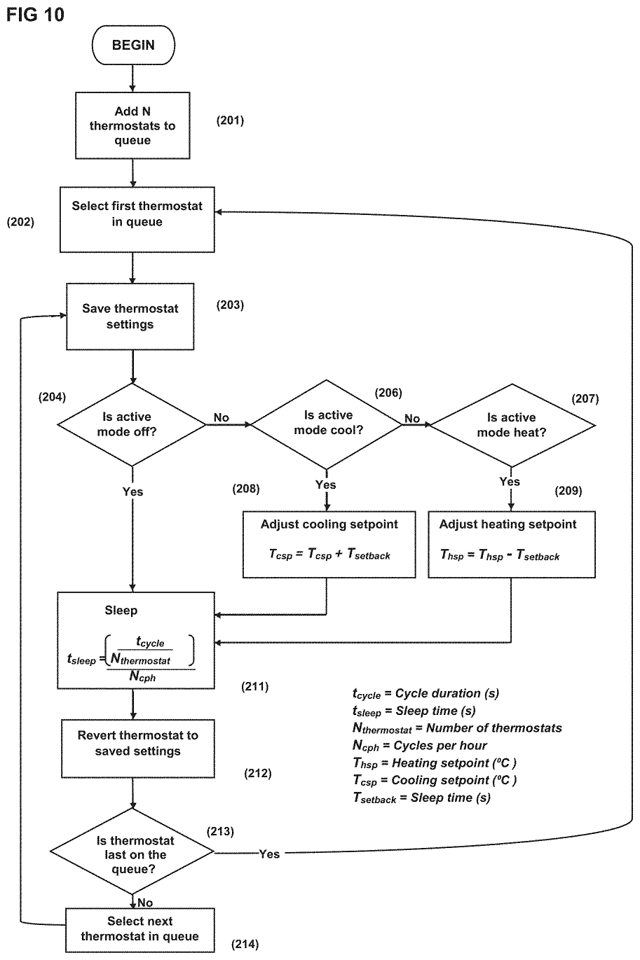

The second aspect of thermostat control is illustrated in the flow chart of FIG. 10. In this example, once the control system is invoked, indicated as ‘BEGIN’ in FIG. 10, a select number of thermostats is added to the queue at step 201. At step 202 the first thermostat in the queue is selected. Again, the selected thermostat's settings are stored at step 203. At step 204 the status of the active mode of the selected thermostat is determined, ie ‘ON’ or ‘OFF’. As with the method illustrated in the flow chart of FIG. 1, if the active mode is determined as ‘OFF’, then a sleep time is determined for the selected thermostat as above at step 211.

However, in this case and in contrast to the steps of FIG. 9, if the active mode of the selected thermostat is determined as ‘ON’, the system then determines whether the active mode of the selected thermostat is ‘COOL’ at step 206. If the selected thermostat is in COOL mode then the cooling setpoint is adjusted at step 208 as follows:
T_{csp}=T_{csp}+T_{setback}
   where
      T_{csp}=Cooling setpoint of selected thermostat (° C.)
      T_{setback}=Sleep time (seconds)

In the event that the active mode of the selected thermostat is not ‘COOL’, then at step 207 it is determined whether the active mode is ‘HEAT’. If so, then the heating setpoint is adjusted at step 209 as follows:
Tₕₛₚ=Tₕₛₚ+T_{setback}
   where
      Tₕₛₚ=Cooling setpoint of selected thermostat
      T_{setback}=Sleep time (seconds)

Once the active mode is determined, either in ‘cooling’ or ‘heating’ and the appropriate adjustment to the relevant setpoint is made, the system then continues and determines a sleep time at 211.

Thereafter at step 212 the selected thermostat is reverted to its saved/stored settings of step 203. With the sleep time programmed into the thermostat, on the expiry of the sleep time, it will operate with its saved settings. In other words, after the cycle period the device will return to its previous state. Whether or not the selected thermostat is the last in the queue is determined at step 213 then at step 214, the next thermostat in the queue is selected for processing as above.

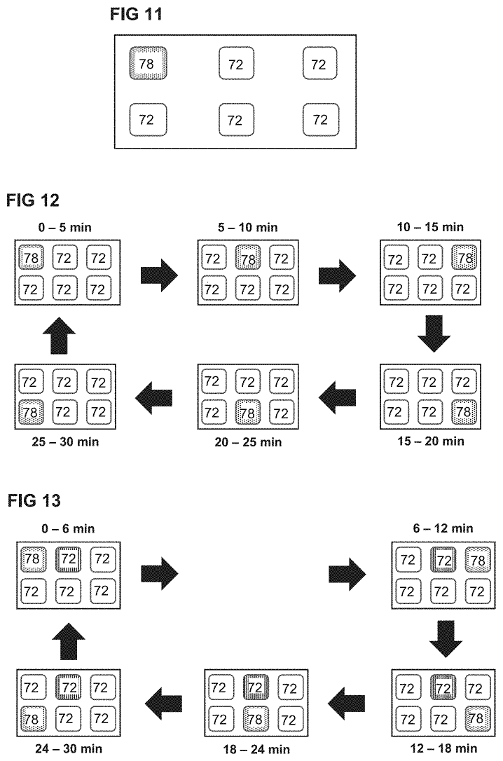

With the above methodology in place, with reference to FIG. 11 activation of thermostats can be shared in a ‘round robin’ fashion with temperature offset. As shown conceptually in FIG. 11, a site contains multiple thermostats connected to an API service via a gateway. In this example, the site has 6 thermostats configured with a single stage of heating and a single stage of cooling. The heating and cooling schedule is set via the API service for the site eg. Heating Set Point=68° F., Cooling Set Point=72° F. and, schedule to operating in a mode of ON between 9 am to 5 pm.

Utilising the method as in the flowcharts of FIGS. 9 and 10, the API service may be configured to have
2×rounds per hour
1×thermostat off per round
+6 F setback per round
60 min/6×stats/2×rounds*1×per round=5 min each off period. By way of explanation for this example, for an hour period, each thermostat within a group is to be in an OFF or setback state twice. If there are 6×thermostats in a group, and each device is off for 5 minutes at each interval, the total time that each device will be off each time is 5 minutes. In this respect, reference is made to FIG. 12, which shows the highlighted (orange) block being off for 5 minutes.

Alternatively, a temperature offset exercise according to an embodiment of the present invention is illustrated in FIG. 12 which has the round circuiting through a number of buildings or stations. Accordingly, FIG. 12 shows that for 6×thermostats in a given room, building, or geographic location, within a half hour period, each thermostat will be setback and off for 5 minutes within a half hour period.

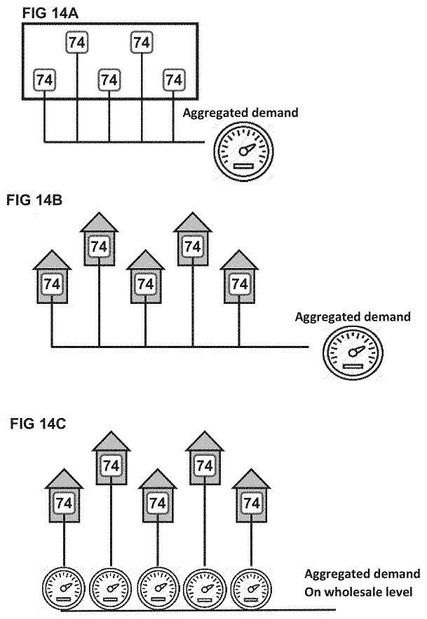

In FIG. 13 another variation to the temperature offset exercise in accordance with an embodiment of the present invention is conducted with exclude or override being utilised for the buildings or stations. Accordingly, FIG. 13 shows that one or more thermostats may be unable to participate in the round robin cycle, as highlighted (red), and is to be left out of the algorithm. A device may be left out as the device is offline due to no power, no communications, etc., or the HVAC system may require maintenance, the participant has decided to opt out for some reason, or manually overridden the setback parameters to explicitly be on rather than participate.

Parameters are to be configured for exemplary methods according to the present invention, where the intention would be to have a main controller, API, or system, that would perform a round robin calculation and issue events or adjustment to the devices within the groups as required. Another option could be that the devices are aware of each other and can self-coordinate the timing to message the next device within the sequence. The configurable parameters for the preferred method of the present invention are as follows.
Input:
   Input Device List (all of the devices at a site and their stages)
   Duty cycle (how many times per hour each thermostat is off) or Period (how long each thermostat is off for)
   Count (Number of devices off per round, this may also be better measured as a percentage rather than count)
   Override (if a thermostat has a manual override and must run for this round)
   Exclude (if a thermostat should be excluded from method of the present invention, eg. Demand Response event active or as defined)
   Calculated:
   Output Device List (list of devices participating in round)Output Device List=Input Device List-Override-Exclude
   Period (how long each thermostat is in a state of ‘off’)
   Period(min)=60 min/count(Output Device List)/DutyCycle*Count
   or Duty Cycle (how many times per hour each thermostat is off)
   DutyCycle(number)=60 min/count(Output Device List)/Period*Count

FIG. 14 illustrates three different applications suitable for implementation of the method of the present invention. FIG. 14A illustrates a system of interdependent HVACs, such as would be found in large retail warehouses, commercial storage facilities, open plan office rooms and so forth.

FIG. 14B illustrates independent HVACs with shared billing such as educational institutes, schools, apartment blocks and so forth.

FIG. 14C illustrates independent HVACs having demand control by the retailer such as apartment blocks, whole suburbs, and the like.

With specific reference to HVAC systems, advantages provided by the present invention comprise include those discussed below.

One advantage offered is the potential for hardware lockout. Without lockout, a user can opt-out and disturb the scheme. The present invention can prevent the user from opting-out.

Furthermore, the present invention offers the potential for communicating with a user through the thermostat and a computer App. For example, it would be possible to communicate reasons why the set-point is increased, how long the DR event is expected to last for and what ambient temperatures (temperature inside the controlled room) can be expected.

Another advantage is that precise coordination is possible if firmware specific properties of the thermostat are known such as, for example, the minimal time-period an RTU is switched ON and the time a fan remains enabled after the compressor is disabled (utilising the “coldness” stored in the coils).

Importantly, the present invention offers flexibility. Each user specifies a trade-off between comfort and savings. A user is able to specify to what degree they would like to participate in a DR event.

The present invention is also dynamic, that is, it allows the aggregated energy consumption to be dynamically adjusted. The method also allows a user to specify the percentage of HVAC's to run simultaneously.

Another advantage is that the building characteristics can be used to predict the time HVAC would be on in normal mode, the increase in temperature if HVAC is off, the HVAC electricity consumption (Eydro) and the consumer preference. Importantly, it is possible to calculate the expected individual and aggregated savings, which is important for the electricity market operator.

The method of the present invention can also be dynamically altered, allowing the market operator to dictate a load savings curve with precision. It is possible to switch load on and off, and in addition, it is possible to dynamically adjust it and contribute more flexibly to demand management schemes.

The present invention can also be adapted to cope with internet outages. For example, given that it is possible to predict the performance of individual rooms and to schedule HVAC operation for a period of time. Furthermore, individual thermostats could be configured to communicate without reference to the internet, such as by using WiFi or Zigbee.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, any means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.
The following sections I-VII provide a guide to interpreting the present specification.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this specification”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present specification, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 2, 3, 4, . . . 9) and non-whole numbers (e.g., 1.1, 1.2, . . . 1.9).

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Indication

The term “indication” is used in an extremely broad sense. The term “indication” may, among other things, encompass a sign, symptom, or token of something else.

The term “indication” may be used to refer to any indicia and/or other information indicative of or associated with a subject, item, entity, and/or other object and/or idea.

As used herein, the phrases “information indicative of” and “indicia” may be used to refer to any information that represents, describes, and/or is otherwise associated with a related entity, subject, or object.

Indicia of information may include, for example, a symbol, a code, a reference, a link, a signal, an identifier, and/or any combination thereof and/or any other informative representation associated with the information.

In some embodiments, indicia of information (or indicative of the information) may be or include the information itself and/or any portion or component of the information. In some embodiments, an indication may include a request, a solicitation, a broadcast, and/or any other form of information gathering and/or dissemination.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology are not Limiting

Neither the Title nor the Abstract in this specification is intended to be taken as limiting in any way as the scope of the disclosed invention(s). The title and headings of sections provided in the specification are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognise that the disclosed invention(s) may be practised with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, operations, algorithms or the like may be described in a particular sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more micro-controllers, one or more digital signal processors) will receive instructions (e.g., from a memory or like device), and execute those instructions, thereby performing one or more processes defined by those instructions.

A “processor” means one or more microprocessors, central processing units (CPUs), computing devices, micro-controllers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fibre optics, including the wires that comprise a system bus coupled to the processor. Transmission media may include or convey acoustic waves, light waves and electromagnetic emissions, such as those generated during radio frequency (RF) and infra-red (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviours of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices that are adapted to communicate with the computer. Any number and type of devices may be in communication with the computer.

In an embodiment, a server computer or centralised authority may not be necessary or desirable. For example, the present invention may, in an embodiment, be practised on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human). It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer and for that matter, any commercial processor may be used to implement the embodiments of the invention either as a single processor, serial or parallel set of processors in the system and, as such, examples of commercial processors include, but are not limited to Merced™, Pentium™, Pentium II™, Xeon™, Celeron™, Pentium Pro™, Efficeon™, Athlon™, AMD™and the like), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML. Moreover, there are hundreds of available computer languages that may be used to implement embodiments of the invention, among the more common being Ada; Algol; APL; awk; Basic; C; C++; Conol; Delphi; Eiffel; Euphoria; Forth; Fortran; HTML; Icon; Java; Javascript; Lisp; Logo; Mathematica; MatLab; Miranda; Modula-2; Oberon; Pascal; Perl; PL/I; Prolog; Python; Rexx; SAS; Scheme; sed; Simula; Smalltalk; Snobol; SQL; Visual Basic; Visual C++; Linux and XML.) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL). Hardware logic may also be incorporated into display screens for implementing embodiments of the invention and which may be segmented display screens, analogue display screens, digital display screens, CRTs, LED screens, Plasma screens, liquid crystal diode screen, and the like.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

We claim:

1. A method of controlling a plurality of sensing devices comprising the steps of:
forming a queue of a plurality of sensing devices;
selecting one of the plurality of sensing devices;
storing the settings of the selected sensing device;
determining at least one active mode of the selected sensing device;
calculating a sleep time for the selected sensing device;
operating the selected device with its stored settings in accordance with the calculated sleep time.

2. A method as claimed in claim 1 wherein the steps of storing, determining, calculating and operating are performed for each of the sensing devices of the queue.

3. A method as claimed in claim 1 wherein the sleep time is calculated according to:
tₛₗₑₑₚ=(t_{cycle}/Nₜₕₑᵣₘₒₛₜₐₜ)/N_{cph}
where
tₛₗₑₑₚ=Sleep time in seconds (s) t_{cycle}=Cycle duration in seconds (s)
Nₜₕₑᵣₘₒₛₜₐₜ=Number of thermostats
N_{cph}=Cycles per hour

4. A method as claimed in claim 1 wherein the step of determining at least one active mode of the selected sensing device includes determining whether the selected device is in one or a combination of the following modes:
ON;
OFF;
COOLING with a corresponding cooling setpoint allocated to the device;
HEATING with a corresponding heating setpoint allocated to the device.

5. A method as claimed in claim 4 where if the selected device is in either COOLING or HEATING mode, an adjusted cooling setpoint or an adjusted heating setpoint is calculated, respectively.

6. A system for controlling a plurality of sensing devices, said system comprising an API service utilising a computer usable medium having computer readable program code and computer readable system code embodied on said medium for reducing peak energy usage across a group of the sensing devices within a data processing system, said computer program product including computer readable code within said computer usable medium for:
forming a queue of sensing devices;
selecting one of the plurality of sensing devices;
storing the settings of the selected device;
determining at least one active mode of the selected device;
calculating a sleep time for the selected sensing device;
operating the selected device with its stored settings in accordance with the calculated sleep time.

7. Apparatus adapted to control a plurality of sensing devices wherein each sensing device is operatively associated with a HVAC device within a HVAC system, said apparatus for reducing peak energy usage across a group of the sensing devices, said apparatus comprising:
processor means adapted to operate in accordance with a predetermined instruction set,
said apparatus, in conjunction with said instruction set, being adapted to perform the method as claimed in claim 1.

8. (canceled)

9. (canceled)
